(19) United States
(12) Patent Application Publication
(10) Pub. No.: US 2024/0248761 A1
(43) Pub. Date: Jul. 25, 2024

(54) SYSTEM AND METHOD FOR INFRASTRUCTURE MANAGEMENT USING SELF DESCRIBING SERVICES

(71) Applicant: Dell Products L.P., Round Rock, TX (US)

(72) Inventors: RAVIKANTH CHAGANTI, Bangalore (IN); DHARMESH M. PATEL, Round Rock, TX (US); RIZWAN ALI, Cedar Park, TX (US)

(21) Appl. No.: 18/159,252

(22) Filed: Jan. 25, 2023

(51) Int. Cl. G06F 9/50

(52) U.S. Cl. CPC G06F 9/5027

(57) ABSTRACT

Methods and systems for managing service deployment are disclosed. To deploy services, dependencies and other characteristics of services may be dynamically analyzed through self-descriptions of the services. The dependencies and other characteristics may be used to identify any number of instances of various instances for deployment to provide a complete service. By dynamically analyzing the self-description of the services, efficiency of use of computing resources may be improved by limiting the deployed services to only those necessary for operation of the complete service.

### FIELD

Embodiments disclosed herein relate generally to operation management. More particularly, embodiments disclosed herein relate to systems and methods to manage deployment of services.

### BACKGROUND

Computing devices may provide computer implemented services. The computer implemented services may be used by users of the computing devices and/or devices operably connected to the computing devices. The computer implemented services may be performed with hardware components such as processors, memory modules, storage devices, and communication devices. The operation of these components and the components of other devices may impact the performance of the computer implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a block diagram illustrating a system in accordance with an embodiment.

FIGS. 2A-2C show diagrams illustrating data flows, processes, and other aspects of a system in accordance with an embodiment.

FIGS. 3A-3B show flow diagrams illustrating methods of managing services in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing services provided by data processing systems. To manage the services, the services may be self-describing. The self-description of the services may allow for dynamic discovery of infrastructure expectations, capabilities, dependencies, and/or other information related to the services.

The self-descriptions of the services may be stored in a repository. The repository may also include images or other data structures usable to instantiate instances of the services.

To establish a complete service (e.g., such as a stack of services that provide a set of functions), any number of services may be selected for deployment based on the complete service. The self-descriptions of the selected services may be analyzed to dynamically identify dependencies of the services. New instances of the selected services and management services to satisfy the identified dependencies may be deployed to obtain a new instance of the complete service. Existing services may be utilized rather than new services being instantiated if compatible instances of services are already available.

By doing so, a system in accordance with embodiments disclosed herein may provide for dynamic deployment of instances of complete services without relying on static or hard coded deployment schemes. For example, by analyzing the dependencies of services and existing services, fewer number of new services may be deployed. In contrast, static or hard coded deployment scheme may cause redundant instances of services to be deployed, thereby needlessly consuming limited computing resources. Thus, embodiments disclosed herein may address, among others, the technical problem of limited computing resources in a system. The disclosed system may address this challenge through dynamic assessment and identification of dependencies for complete services.

In an embodiment, a method for managing services provided by data processing systems is provided. The method may include identifying an artifact associated with a service of the services; instantiating an instance of the service based on a service image of the artifact; instantiating an instance of a complementary service for the instance of the service based on a manifest associated with the service image; identifying a dependency based on the instance of the service, the instance of the complementary service, or the manifest; identifying a management service for the instance of the service based on the dependency; and instantiating an instance of the management service to establish a complete service.

Instantiating the instance of the service may include instantiating a container for the instance of the service; and populating the container based on the service image.

Instantiating the instance of the complementary service may include instantiating a sidecar for the instance of the complementary service; and populating the sidecar based on the manifest.

The container and sidecar may be members of a pod that shares a context.

The manifest may specify infrastructure expectations for the service; application programming interfaces for the service; and capabilities of the service.

Identifying the artifact may include obtaining a list specifying: identifiers of a set of services for the complete service, and capability requirements for the set of services; and making an identification that no executing instance of at least one of the services indicated by the identifiers of the set of services exists; selecting the service of the services for deployment based on identification; and performing a search of an artifact repository based on the selected service.

The complete service may include a first set of instances of services that contribute to a function provided by the complete service, and a second set of instances of management services that contribute to management of the first set of instances of the services.

In an embodiment, a non-transitory media is provided. The non-transitory media may include instructions that when executed by a processor cause the computer implemented method to be performed.

In an embodiment, a data processing system is provided. The data processing system may include the non-transitory media and a processor, and may perform the computer implemented method when the computer instructions are executed by the processor.

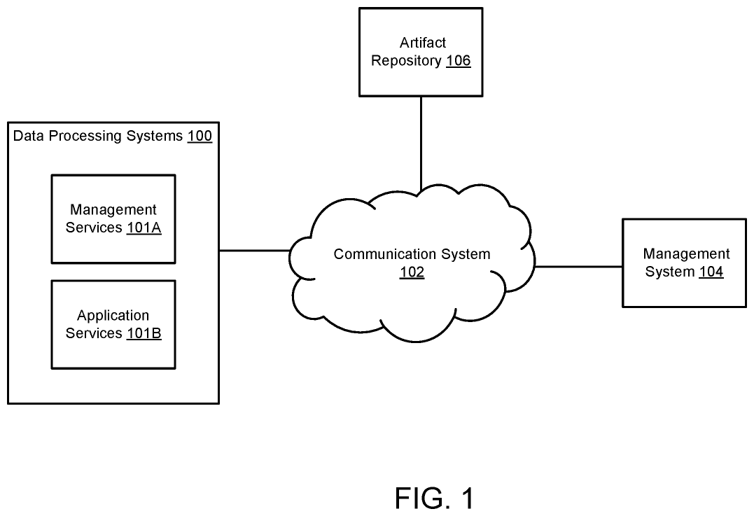

Turning to FIG. 1, a block diagram illustrating a system in accordance with an embodiment is shown. The system shown in FIG. 1 may provide computer implemented services. The computer implemented services may include any type and quantity of computer implemented services. For example, the computer implemented services may include data storage services, instant messaging services, database services, and/or any other type of service that may be implemented with a computing device.

To provide the computer implemented services, the system may include any number of data processing systems 100. Data processing systems 100 may provide the computer implemented services to users of data processing systems 100 and/or to other devices (not shown). Different data processing systems may provide similar and/or different computer implemented services.

To provide the computer implemented services, data processing systems 100 may include various hardware components (e.g., processors, memory modules, storage devices, etc.) and host various software components (e.g., operating systems, application, startup managers such as basic input-output systems, etc.). These hardware and software components may provide the computer implemented services via their operation.

The software components may be implemented using various types of services. For example, data processing systems 100 may host various application services 101B that provide the computer implemented service. Data processing systems 100 may also host management services 101A that support and manage the operation of application services 101B. The aggregate management and application services may be a complete service that provide desired functionalities.

In general, embodiments disclosed herein may provide methods, systems, and/or devices for providing computer implemented services using complete services. To provide the computer implemented services, various services corresponding to a complete service may be instantiated. As demand for different types of computer implemented services changes over times, different types of complete services may be instantiated.

To manage complete service instantiation, the system of FIG. 1 may include management system 104 and artifact repository 106. Each of these components is discussed below.

Management system 104 may (i) identify management services and application services (e.g., in aggregate, a “set of required services”) for complete services, (ii) identify existing services that may be used to meet the set of required services for new complete services, (iii) instantiate new instances of services to satisfy the set of required services for a complete service, and (iv) initiate operation of the new complete service using the identified existing services and newly instantiated services. When providing its functionality, management system 104 may utilize information stored in artifact repository 106 to identify the set of required services.

Artifact repository 106 may store information regarding various types of services. The information may include (i) manifests that include descriptions of requirements, capabilities, and other characteristics of services, and (ii) images of the services usable to instantiate new instances of the services. The manifests may facilitate self-description of the services usable during instantiation of new complete services to identify the set of required services. Once identified, the set of required services may facilitate stitching together of new and existing services to establish new instances of complete services.

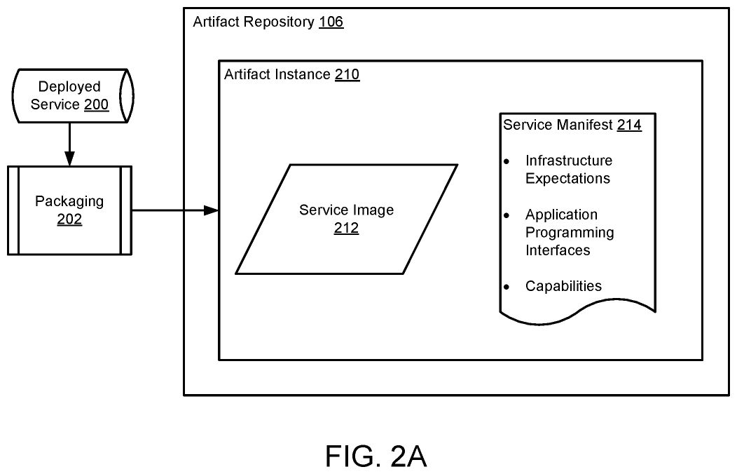

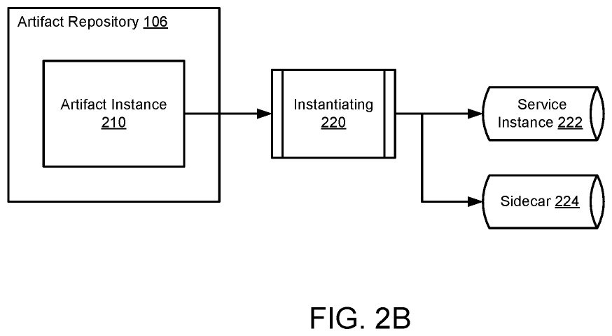

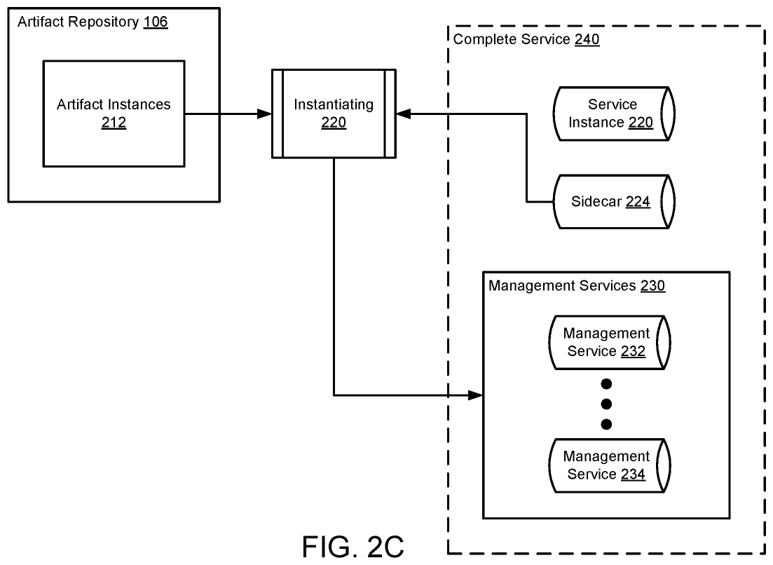

By doing so, embodiments disclosed herein may facilitate deployment of new complete services without relying on static descriptions or hard coded plans for deploying new instances of complete services. For example, the disclosed system may facilitate dynamic identification, deployment, and stitching (e.g., integration and management) of new and existing services. Refer to FIGS. 2A-2C for additional details regarding information stored in artifact repository 106, and deployment of complete services.

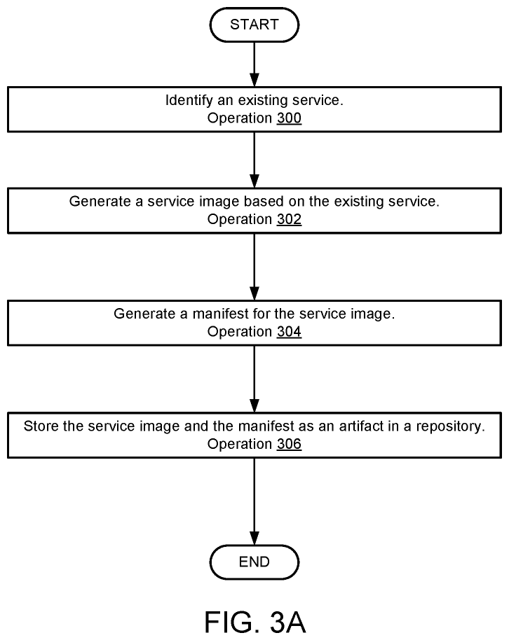

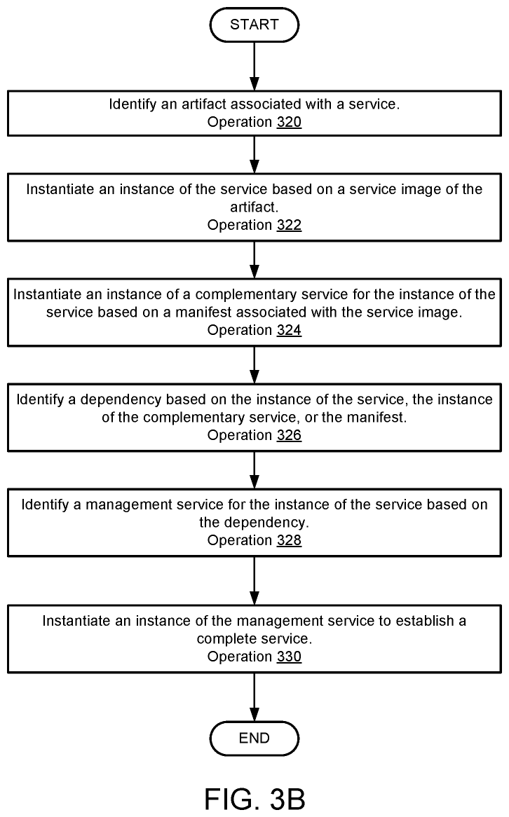

When providing its functionality, management system 104 and/or artifact repository 106 may perform all, or a portion, of the methods illustrated in FIGS. 3A-3B.

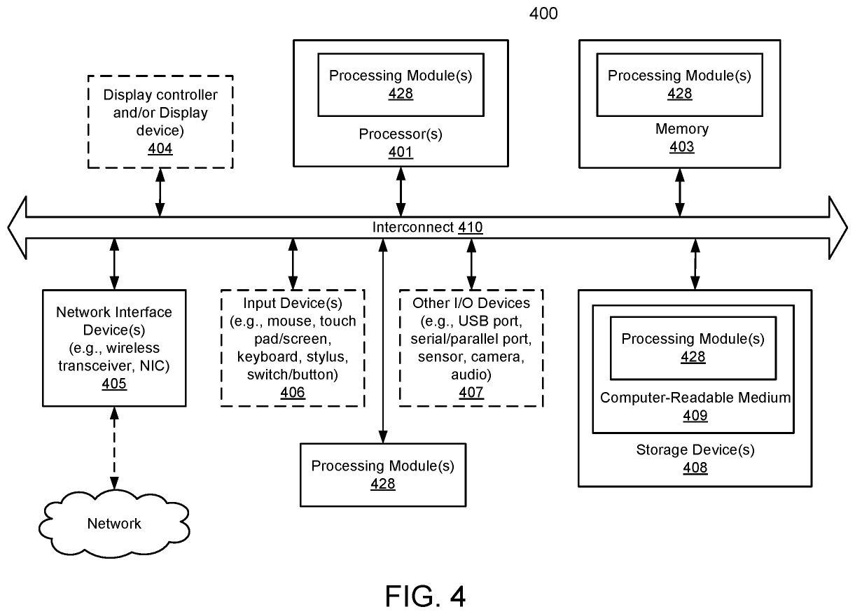

Any of management system 104 and/or artifact repository 106 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 4.

Data processing systems 100 may be implemented with multiple computing devices. The computing devices of data processing system 100 may perform similar and/or different functions.

Any of the components illustrated in FIG. 1 may be operably connected to each other (and/or components not illustrated) with communication system 102. In an embodiment, communication system 102 includes one or more networks that facilitate communication between any number of components. The networks may include wired networks and/or wireless networks (e.g., and/or the Internet). The networks may operate in accordance with any number and types of communication protocols (e.g., such as the Internet Protocol).

While illustrated in FIG. 1 as including a limited number of specific components, a system in accordance with an embodiment may include fewer, additional, and/or different components than those illustrated therein.

To further clarify embodiments disclosed herein, diagrams illustrating data flows implemented by and data structures used by a system over time in accordance with an embodiment are shown in FIGS. 2A-2C. In FIGS. 2A-2C, data structures are represented using a first set of shapes (e.g., 212, 214, etc.), services are represented using a second set of shapes (e.g., 200), and processes are represented using a third set of shapes (e.g., 202).

Turning to FIG. 2A, a first data flow diagram illustrating data flows, data processing, and/or other operations that may be performed by the system of FIG. 1 in accordance with an embodiment is shown.

To populate artifact repository 106, existing deployed services (e.g., 200) may (e.g., when created initially, or after created) be analyzed and used as basis for new artifact instances (e.g., 210). The artifact instances of artifact repository 106 may include (i) information usable to instantiate an instance of the service, and (ii) information usable to identify dependencies for the service. To generate an artifact instance, packaging 202 may be performed. During packaging, information regarding a deployed service may be collected and added to an artifact instance.

For example, service image 212 and service manifest 214 may be added to artifact instance 210 to establish an artifact for deployed service 200. Deployed service 200 may be a part of a complete service that may provide any type of functionality.

Service image 212 may include binaries or other data structures usable to instantiate an executing instance of deployed service 200.

Service manifest 214 may include metadata that describes deployed service 200. For example, service manifest 214 may include information regarding (i) infrastructure expectations (e.g., numbers and capabilities of hardware devices, or other quantifications regarding computing resources that may need to be available for nominal operation of an instance of deployed service 200), (ii) application programming interfaces presented by deployed service 200, and/or (iii) capabilities of instances of deployed service 200.

The information regarding the application programming interfaces (APIs) may specify, for example, the commands available via the AIPs. The capabilities may indicate, for example, identifiers for the capabilities, descriptions (e.g., human readable) of the capabilities, dependencies for the capabilities to be provided, criteria used to discriminate the capabilities from other capabilities (e.g., platforms to which the capabilities are relevant, the types of devices that may desire access to/use/provide the capabilities, etc.), and/or other types of information.

Artifact repository 106 may include any number of artifact instances for any number and types of services. The artifact instances may be implemented with any number and type of data structure (e.g., linked lists, tables, databases, etc.).

Turning to FIG. 2B, a second data flow diagram illustrating data flows, data processing, and/or other operations that may be performed by the system of FIG. 1 in accordance with an embodiment is shown.

To establish a new complete service, artifact instances of artifact repository 106 may be used to establish new service instances, identify dependences of the services instances, and establish instances of management services to manage the operation of the complete service.

For example, when a new complete service is to be instantiated, an artifact instance (e.g., 210) for a service may be used during instating 220 as a basis for new executing instances. The service image may be used to instantiate service instance 222, and the manifest may be used to establish sidecar 224. Service instance 222 and sidecar 224 may be instantiated using any service deployment technique. For example, both may be instantiated as containers. The containers may be members of a pod that share a same context (e.g., shared memory, computing resources, etc.).

Sidecar 224 may expose the capabilities of service instance 222 as specified by the service manifest of artifact instance 210. Consequently, the dependencies for service instance 222 may be identified.

For example, to properly execute, service instance 222 may presume that certain other services exist. These other services may be specified by the service manifest. Accordingly, once instantiated, the containers for service instance 222 and sidecar 224 may be populated using the service image and corresponding dependencies thereby allowing service instance 222 to utilize the service provided by sidecar 224 during operation.

While illustrated in FIG. 2B with respect to an instantiation for a single service, it will be appreciated that this process may be repeated any number of times to establish any number of executing service instances and corresponding sidecars to obtain a complete service.

Turning to FIG. 2C, a third data flow diagram illustrating data flows, data processing, and/or other operations that may be performed by the system of FIG. 1 in accordance with an embodiment is shown.

To establish complete service 240, any number of management services 230 may be established based on the dependencies of the other services. To do so, service manifests of various artifact instances (e.g., 212) may be evaluated to identify those having capabilities that meet the dependencies of the service instances. Once identified, corresponding management services (e.g., 232, 234) may be established based on the service images corresponding to the service manifests of artifact instance 210 that indicate capabilities sufficient to meet the dependencies. Sidecars (not shown) similar to sidecar 224 may also be instantiated for the management services.

In contrast to service instance 222 that may contribute to functionality of complete service 240 used by other entities, management services 230 may provide for control and management of complete service 240. For example, management services 230 may establish a management place for the service instances of complete service 240.

Any of the services described with respect to FIGS. 2A-2C may be implemented using, for example, processes (e.g., executing code within a computing environment), containers that host instances of processes, and/or other architectures for implementing and combining different functionalities to provide a complete service.

As discussed above, the components of FIG. 1 may perform various methods to deploy and manage complete solutions. FIGS. 3A-3B illustrate methods that may be performed by the components of FIG. 1. In the diagrams discussed below and shown in FIGS. 3A-3B, any of the operations may be repeated, performed in different orders, and/or performed in parallel with or in a partially overlapping in time manner with other operations.

Turning to FIG. 3A, a flow diagram illustrating a method obtaining artifact instances in accordance with an embodiment is shown. The method may be performed by components of the system shown in FIG. 1.

At operation 300, an existing service is identified. The existing service may be identified, for example, when the service is created. The service may be created, for example, by an administrator other person initiating execution of computer code corresponding to the service.

The service may be a part of a complete solution. For example, the existing service may be deployed along with any number of other services. The deployed services may be the complete solution.

At operation 302, a service image is generated based on the existing service. The service image may be generated using any image generation process. For example, a data structure may be instantiated, and copies of the computer code for the existing service may be stored in the data structure. Configuration settings and/or other configuration data may also be stored in the data structure.

Copies of various in-memory data structures may also be stored. For example, the in-memory data structures may be obtained by copying the data stored in memory utilized by the existing service.

The service image may also include, for example, a set of instructions for instantiating a copy of the existing service using the service image. The instructions may specify, for example, how data for the new instance of the service is to be arranged such that initiation of execution of the computer code may result in successful operation of a new instance of the existing service.

At operation 304, a manifest (e.g., a service manifest) for the service image is generated. The manifest may be generated using an automated analysis process. The analysis process may (i) identify APIs presented by the existing service, (ii) capabilities of the existing service, (iii) dependencies of the existing service (e.g., lists of services utilized by existing service), (iv) computing resources typically consumed (or maximally consumed) by the existing service, and/or other types of information regarding existing service. The aforementioned information may be used to populate the manifest.

The manifest may also be generated by obtaining input from a user (e.g., an administrator) that instantiated the existing service. The input may reflect, for example, descriptions of the capabilities in a format readable by a human.

At operation 306, the service image and the image are stored as an artifact in a repository. When storing the artifact, various information may be added to the repository so that the artifact may be discriminated from other artifacts based on any number of criteria such as, for example, an identifier for the existing service, membership of the existing service in a complete service, capabilities of existing service, etc. For example, associations based on the criteria may be established to facilitate performance of lookups or other discrimination operations.

The method may end following operation 306.

Using the method illustrated in FIG. 3A, any number of artifacts may be obtained for a complete service. Consequently, when a new copy of the complete service is to be established, the services necessary (e.g., services, dependencies of the services) for the new instance of the complete service may be identified and instantiated using the repository.

Turning to FIG. 3B, a flow diagram illustrating a method obtaining an instance of service in accordance with an embodiment is shown. The method may be performed by components of the system shown in FIG. 1.

At operation 320, an artifact associated with a service is identified. The service may be a member of a complete service. The artifact may be identified by performing a lookup using an identifier of the service as a key.

At operation 322, an instance of the service is instantiated based on a service image of the artifact. The service may be instantiated, for example, by (i) initiating execution of a process using the service image, (ii) establishing a container, and/or (iii) establishing a pod for the container.

At operation 324, an instance of a complementary service for the instance of the service is instantiated based on a manifest associated with the service image. The complementary service may be instantiated by (i) establishing a sidecar for the container, (ii) adding the sidecar to the pod, and (iii) initiating execution of one or more processes in the sidecar. The sidecar may expose capabilities of the service in the container.

At operation 326, a dependency based on the instance of the service, the instance of the complementary service, or the manifest is identified. The dependency may be identified by analyzing these data structures to identify at least one management service through which the service may be managed.

For example, the manifest may be reviewed to identify any services which the capabilities of the service (e.g., instantiated in operation 322) depend on for successful operation. Thus, a self-description of the service may be used as a basis for management of the service. Accordingly, static or hard coded dependencies may not need to be available for the service to be successfully operated.

At operation 328, a management service for the instance of the service is identified based on the dependency. The management service may be identified by performing a lookup for an artifact based on an identifier for the management service indicated by the dependency.

At operation 330, an instance of the management service is instantiated to establish a complete service. The instance of the management service may be instantiated similarly to as described with respect to instantiation of the service and complementary service in operations 322 and 324. For example, a service image of the artifact identified in operation 328 may be used to instantiate the management service, and sidecars may be established based on the manifest corresponding to the service image.

The method may end following operation 330.

Using the method illustrated in FIG. 3B, a system in accordance with an embodiment may be able to dynamically deploy instances of complete services using self-describing services. For example, any number of services and management services may be deployed using the method illustrated in FIG. 3B. By dynamically identifying dependencies and other considerations based on the self-descriptions of the services constituting the complete service, any number of additional services (e.g., management services) may be identified and deployed so that the complete solution may be more likely to successfully operate.

Any of the components illustrated in FIGS. 1-2C may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OSR/iOS® from Apple, Android® from Google®, Linux, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as a SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing services provided by data processing systems, the method comprising:
identifying an artifact associated with a service of the services;
instantiating an instance of the service based on a service image of the artifact;
instantiating an instance of a complementary service for the instance of the service based on a manifest associated with the service image;
identifying a dependency based on the instance of the service, the instance of the complementary service, or the manifest;
identifying a management service for the instance of the service based on the dependency; and
instantiating an instance of the management service to establish a complete service.

2. The method of claim 1, wherein instantiating the instance of the service comprises:
instantiating a container for the instance of the service; and
populating the container based on the service image.

3. The method of claim 2, wherein instantiating the instance of the complementary service comprises:
instantiating a sidecar for the instance of the complementary service; and
populating the sidecar based on the manifest.

4. The method of claim 3, wherein the container and sidecar are members of a pod that share a context.

5. The method of claim 4, wherein the manifest specifies:
infrastructure expectations for the service;
application programming interfaces for the service; and
capabilities of the service.

6. The method of claim 5, wherein identifying the artifact comprises:
obtaining a list specifying:
identifiers of a set of services for the complete service, and
capability requirements for the set of services; and
making an identification that no executing instance of at least one of the services indicated by the identifiers of the set of services exists;
selecting the service of the services for deployment based on identification; and
performing a search of an artifact repository based on the selected service.

7. The method of claim 6, wherein the complete service comprises:
a first set of instances of services that contribute to a function provided by the complete service, and
a second set of instances of management services that contribute to management of the first set of instances of the services.

8. A non-transitory machine-readable medium having instructions stored therein, which when executed by a processor, cause the processor to perform operations for managing services provided by data processing systems, the operations comprising:
identifying an artifact associated with a service of the services;
instantiating an instance of the service based on a service image of the artifact;
instantiating an instance of a complementary service for the instance of the service based on a manifest associated with the service image;
identifying a dependency based on the instance of the service, the instance of the complementary service, or the manifest;
identifying a management service for the instance of the service based on the dependency; and
instantiating an instance of the management service to establish a complete service.

9. The non-transitory machine-readable medium of claim 8, wherein instantiating the instance of the service comprises:
instantiating a container for the instance of the service; and
populating the container based on the service image.

10. The non-transitory machine-readable medium of claim 9, wherein instantiating the instance of the complementary service comprises:
instantiating a sidecar for the instance of the complementary service; and
populating the sidecar based on the manifest.

11. The non-transitory machine-readable medium of claim 10, wherein the container and sidecar are members of a pod that share a context.

12. The non-transitory machine-readable medium of claim 11, wherein the manifest specifies:
infrastructure expectations for the service;
application programming interfaces for the service; and
capabilities of the service.

13. The non-transitory machine-readable medium of claim 12, wherein identifying the artifact comprises:
obtaining a list specifying:
identifiers of a set of services for the complete service, and
capability requirements for the set of services; and
making an identification that no executing instance of at least one of the services indicated by the identifiers of the set of services exists;
selecting the service of the services for deployment based on identification; and
performing a search of an artifact repository based on the selected service.

14. The non-transitory machine-readable medium of claim 13, wherein the complete service comprises:
a first set of instances of services that contribute to a function provided by the complete service, and
a second set of instances of management services that contribute to management of the first set of instances of the services.

15. A data processing system, comprising:
a processor; and
a memory coupled to the processor to store instructions, which when executed by the processor, cause the processor to perform operations for managing services provided by data processing systems, the operations comprising:
identifying an artifact associated with a service of the services;
instantiating an instance of the service based on a service image of the artifact;
instantiating an instance of a complementary service for the instance of the service based on a manifest associated with the service image;
identifying a dependency based on the instance of the service, the instance of the complementary service, or the manifest;
identifying a management service for the instance of the service based on the dependency; and
instantiating an instance of the management service to establish a complete service.

16. The data processing system of claim 15, wherein instantiating the instance of the service comprises:
instantiating a container for the instance of the service; and
populating the container based on the service image.

17. The data processing system of claim 16, wherein instantiating the instance of the complementary service comprises:
instantiating a sidecar for the instance of the complementary service; and
populating the sidecar based on the manifest.

18. The data processing system of claim 17, wherein the container and sidecar are members of a pod that share a context.

19. The data processing system of claim 18, wherein the manifest specifies:
infrastructure expectations for the service;
application programming interfaces for the service; and
capabilities of the service.

20. The data processing system of claim 19, wherein the complete service comprises:
a first set of instances of services that contribute to a function provided by the complete service, and
a second set of instances of management services that contribute to management of the first set of instances of the services.
